(19) United States
(12) Patent Application Publication
(10) Pub. No.: US 2026/0146706 A1
(43) Pub. Date: May 28, 2026

(54) Locking Assembly for Mounting Device to Solid Surface with Radial Spring Securing Mechanism

(71) Applicant: Control Dynamics, Inc., Everett, WA (US)

(72) Inventor: Eric Moran, Everett, WA (US)

(21) Appl. No.: 18/962,588

(22) Filed: Nov. 27, 2024

(51) Int. Cl. F16M 13/02; F16M 13/04

(52) U.S. Cl. CPC F16M 13/02; F16M 13/04; F16M 2200/021

(57) ABSTRACT

A locking assembly having a substantially joined bracket assembly with a front and back plate defining an opening therebetween with a slot. At least the back plate is directly or indirectly fixedly attached to a solid surface. Positioned within the slot is a dual-pivoting release lever having an upper leg, a middle leg, and lower leg movable about a first and second pivots. Further, a pivoting release lever is positioned adjacent to the collar assembly and the bracket assembly, the pivoting release lever further including that includes a radial spring disposed between a lower leg member of the pivoting release lever and a middle leg member of the pivoting release lever configured to bias the collar assembly in a locked position in the slot when engaged The lower member also includes one or more compression springs disposed on the lower leg member configured to bias an engaged collar assembly to be dislodged.

### BACKGROUND

Known locking mechanisms for mounting a device to a solid surface include convoluted mechanisms that do not sufficiently lock the device to the solid surface. For example, a conventional sliding latch (in which a dog pan may be attached to a vertical surface (e.g., a wall)) does not lock the device to the solid surface (wall) and can be knocked off by a rambunctious pet. Moreover, known locking mechanisms do not have simplicity of design and ease of installation and dislodgment of a device, yet provide sufficient locking capabilities for joining a variety of devices to a solid surface, yet remain relatively easy to dislodge when required.

Furthermore, known locking mechanisms make audible noise when locked or latched, which may be problematic for particular applications, such as those involving military or other tactical maneuvers.

### BRIEF DESCRIPTION OF THE DRAWINGS

Various aspects and many of the attendant advantages of the subject matter disclosed herein will become more readily appreciated as the same becomes better understood by reference to the following detailed description when taken in conjunction with the accompanying drawings, wherein:

FIG. 1 is an exploded perspective view illustrating a locking assembly having a bracket assembly, a dual-pivoting release lever, and a collar assembly according to an embodiment of the subject matter disclosed herein;

FIG. 2 is a front view similar to FIG. 1 where the assembled components are illustrated in the fully inserted and locked position according to an embodiment of the subject matter disclosed herein;

FIG. 3 is a perspective view of the locking assembly of FIG. 1 shown with a device (dog dish) fixedly attached to a collar assembly that is secured and locked to a solid surface (a wall) according to an embodiment of the subject matter disclosed herein;

FIG. 4 is an enlarged view of the embodiment illustrated in FIG. 1, with a bracket assembly attached to a band such as a belt according to an embodiment of the subject matter disclosed herein; and

FIG. 5 is a view of the locking assembly system and belt of FIG. 4 worn by a person according to an embodiment of the subject matter disclosed herein.

### DETAILED DESCRIPTION

The following discussion is presented to enable a person skilled in the art to make and use the subject matter disclosed herein. The general principles described herein may be applied to embodiments and applications other than those detailed above without departing from the spirit and scope of the subject matter disclosed herein. This disclosure is not intended to be limited to the embodiments shown but is to be accorded the widest scope consistent with the principles and features disclosed or suggested herein.

By way of an overview, embodiments are directed to a locking assembly for attaching and locking a device to a solid surface that is easy to operate and has minimal moving parts that can break or fail. The locking assembly includes a bracket assembly having a front plate and a back plate joined about a substantial periphery of the two plates to form an opening between the two plates and slot (having a top opening and a side opening. Positioned within the slot at the side opening is a dual-pivoting release lever having an upper leg, a middle leg, and a lower leg joined together about a first pivot and a second pivot. The first pivot is attached to the front and back plates to allow the upper, middle, and lower legs of the dual-pivoting release lever to rotate together within a defined boundary of the slot between the front and back plates about the first pivot. The locking assembly also includes a second pivot disposed between the middle leg and the upper leg that allows pivoting motion between the upper leg (e.g., a hold-down flange) and the middle leg.

The locking assembly further includes a collar assembly having a collar assembly plate that is of a size and shape to be received edgewise into the slot. Attached to a front surface of the collar assembly plate is a collar that is attached to a device. The collar is of a size and shape to be received into the slot. The dual-pivoting release lever is positioned within the side opening of the slot adjacent the collar assembly plate. To lock the device to a solid surface, the collar assembly plate is received into the top opening such that a lower edge of the plate applies a force onto the lower leg of the dual-pivoting release lever. This force, in turn, forces the middle and upper legs to swing upwardly about the pivot. A hold-down flange (e.g., the upper member), which extends inwardly of the opening and is attached to the middle leg, restrains the upper edge of the collar assembly plate from upward movement once the collar assembly plate is inserted into the opening. In this manner, the device is secured and locked to the bracket assembly, which is secured to the solid surface such as a wall, a column, or even a belt or vest. Thus, the device is locked to the solid surface.

To unlock and dislodge the collar assembly plate (and, ergo, the device) from the bracket assembly (and solid surface), a force is applied to the upper leg via the hold-down flange. The single motion of the pivoting release lever moves the lower leg upward to apply a dislodging force to the lower edge of the collar assembly plate. Thus, the collar assembly and device are unlocked from the bracket assembly and may be readily removed from the bracket assembly (and, ergo, the solid surface). To assist with applying this force, a radial member is disposed about the second pivot point to provide more force moment to the second pivot point, thereby easing the release of the hold-down flange.

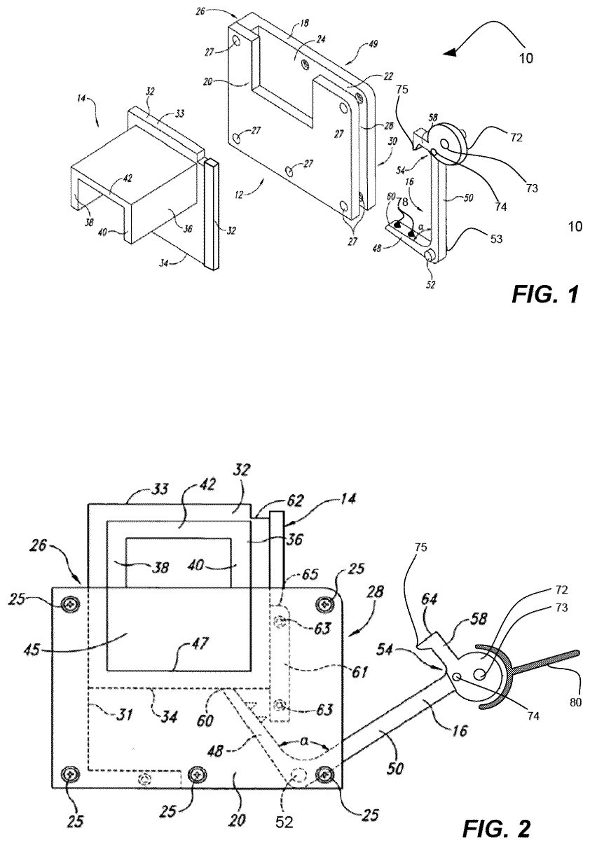

These and other advantages will become more apparent with respect to the following detailed description, FIGS. 1-5, and the claims.

Referring to FIG. 1, a locking assembly 10 of this embodiment includes a bracket assembly 12, and a corresponding collar assembly 14, and a dual-pivoting release lever 16, that, when assembled, allows quick secure fixation and locking of the collar assembly 14 to the bracket assembly 12 through a single motion locking movement of the dual-pivoting release lever 16. Similarly, dislodgement of an attached device (not shown)and collar assembly 14 can be equally easily obtained through the reverse action via the dual-pivoting release lever 16.

The bracket assembly 12 may be formed of a substantially rectangular back plate 18 and a substantially conforming mostly rectangular front plate 20 that are conjoined and spaced apart in such a way as to form a substantially continuous slot 22 between back plate 18 and front plate 20. Slot 22 forms a top opening 24 at the top 26 of bracket assembly 12 and a side opening 28 on one side 30 of the bracket assembly 12. The front plate 20 and the back plate 18 are joined together at portions of the peripheries of the two plates, with side slot 28 being accessible on one side, and the opposite side being joined to form an abutment edge 31, which will be discussed further below.

According to one embodiment, front plate 20 and back plate 18 are formed of two separate machined plates that are joined together primarily about portions of their peripheries by a plurality of fasteners 25, such as screws or rivets, which may be inserted into a plurality of openings 27. If screws are used to fasten the front and back plates together, openings 27 are preferably countersunk. Alternatively, the bracket assembly 12 may be made of a unitary cast or molded piece in which the front plate 20 and back plate 18 are already joined substantially at the periphery of the two plates.

Collar assembly 14 includes a collar assembly plate 32 having a top edge 33 and a bottom edge 34. Collar assembly plate 32 is of a size and shape to be received into top opening 24 such that bottom edge 34 of the collar assembly plate 32 substantially conforms to the shape of the top slot and that substantially all of the collar assembly plate 32 may be received edgewise within slot 22 via top opening 24. In this embodiment, collar assembly plate 32 is rectangular in shape with two planar and parallel surfaces and with the top 33 and bottom edge 34 surfaces also being rectangular in shape.

In addition to collar assembly plate 32, collar assembly 14 includes a collar 36 that is fixedly attached and extends outwardly from one side of collar assembly plate 32. Although the collar 36 can be of many shapes, some of which are discussed in further detail below, the shape of the collar 36 in FIG. 1 is where the collar 36 is fixedly attached substantially perpendicularly of the collar assembly plate 32.

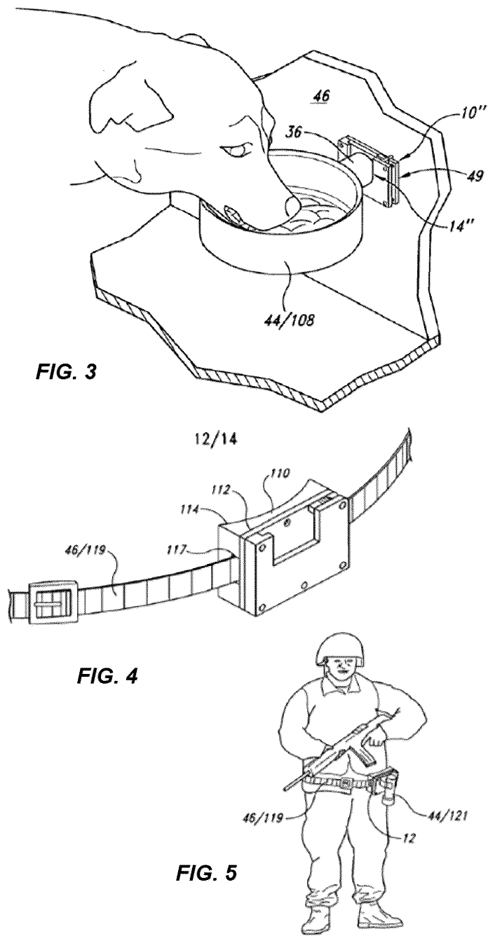

In a first embodiment of the collar 36, the collar 36 is comprised of a channel having two opposed sidewalls 38, 40 and a top wall 42 joined to and connecting upper surfaces of sidewalls 38 and 40. The collar 36 is attached to a device 44 (see FIGS. 3-5 for example), of which can be varied and discussed further below, in order to readily secure and lock the device to a solid surface 46 (e.g., a wall), and, upon need, dislodge/unlock and remove the device from the solid surface.

The locking assembly for securely attaching a device to a solid surface, further includes a dual-pivoting release lever 16. The a dual-pivoting release lever 16 is positioned adjacent to the collar assembly and the bracket assembly and fixed, yet pivotally attached at a first pivot point 52. The dual-pivoting release lever 16 incorporates the first pivot point 52 disposed between a lower leg member 48 and a middle leg member 50, the first pivot point 52 attached to the bracket assembly 12 such that the dual-pivoting release lever 16 can freely pivot within the slot 22 between a first locked position and a first dislodged position. The dual-pivoting release lever 16 also incorporates a second pivot point 74 disposed between an upper leg member 58 and the middle leg member 50, the second pivot point 74 separate from the bracket assembly 12 such that the upper leg member 58 and the middle leg member 50 can freely pivot with respect to each other and away from the bracket assembly 12.

The locking assembly 10 further comprises a means for restraining pivoting movement about the first pivot point 52 of the dual-pivoting release lever 16 when the dual-pivoting release lever 16 is positioned to restrain movement of the collar assembly plate 32 relative to bracket assembly 12 when the collar assembly plate 32 is substantially inserted within the slot 22. Additionally, the locking assembly 10 further comprises a means for securing at least the back plate 18 of the bracket assembly 12 to a solid surface such as a wall (46 of FIG. 3), side of a ship or a belt worn by a human. In this manner the locking assembly 10 includes a dual-pivoting release lever 16 wherein the upper leg member 58, middle leg member 50, and lower leg member 48 (sometimes called legs) form a substantially C-shaped angle when joined at the pivot points 52 and 74.

The locking assembly 10 further comprises one or more compression springs 78 disposed on the lower leg 48 and configured to bias a bottom edge of the collar assembly plate 32 when the collar assembly plate 32 is locked into the bracket assembly 12. The locking assembly 10 further includes a hold-down flange 76 positioned proximal of the upper leg member 58 and directed downward toward the lower leg member 48 wherein the hold down flange 76 is sized to fit over and closely confront a portion of the upper edge notch 62 of the collar assembly plate 32 when the collar assembly plate 32 is inserted within the slot 22.

The locking assembly 10 further includes a first biasing spring 73 radially disposed about the first pivot point 74 which is configured to bias the collar plate assembly 32 in a locked position when the collar plate assembly 32 is inserted into the slot 22. The locking assembly 10 may further include a second biasing spring 53 radially disposed about the second pivot point 52 and also configured to bias the collar plate assembly 32 in a locked position when the collar plate assembly 32 is inserted into the slot 22. The locking assembly 10 may further include a radial body member 72 disposed about the first pivot point 74 and configured to provide rotation leverage to the upper leg member 58 when rotational force is applied. This rotational force acts to pivot the upper leg member 58 upward with respect the middle leg member 50 and the pivot point 74.

The overall locking assembly 10 system may include an additional tool 80 configured to engage the radial body member 72 disposed about the first pivot point 74 and such that additional leverage to apply rotational force is facilitated. Attention is now tuned to FIG. 2 where these concepts are further illustrated in a plan view.

As best illustrated in FIG. 2, the bottom edge 34 of collar assembly plate 32 is inserted into top opening 24 of bracket assembly 12, which is also preferably rectangular in shape. Collar 36 is of shape to be received with an opening 45 of front plate 20. Sidewalls 38, 40 abut a bottom edge 47 of opening 45 when collar assembly plate 32 is fully inserted into top opening 24.

The dual-pivoting release lever 16 includes a first leg 48 and a second leg 50 to which a pivot 52 intersects these two legs. The two joined legs 48, 50 form substantially L-shaped angle α between the two legs at the pivot. In preferred form, the angle α is near or at 90 degrees to form an approximate “L” shape (or backwards “L”) consisting of legs 48 and 50 and pivot 52. At the upper end 54 of leg 50 is an upper leg member 58 and extending inwardly of the lever and leg 50 is an upper hold-down flange 64 that is used to secure (lock) the upper edge 33 of the collar assembly plate 32 within top slot 24.

Dual-pivoting release lever 16 is positioned within opening 22 at side opening 26 between the back and front plates 18, 20 respectively. Pivot 52 is attached to the back and front plates, but still allows rotational movement. Thus, pivot 52 secures dual-pivoting release lever 16 to the back and front plates, but the dual-pivoting release lever 16 is free to move within opening 22 between the back and front plates 18, 20 about pivot 52 save for retaining structure discussed below.

Referring particularly to FIG. 2, at the other end of the dual-pivoting release lever 16 is a distal end 60 of leg 48. Distal end 60 makes contact with bottom edge 34 of collar assembly plate 32 during insertion and release. The insertion of the collar assembly plate 32 and collar 36 into the top opening 24 of slot 22 between the front and back plates of the bracket assembly and retained by abutment edge 31 and an opposite situated elongated guide 61 applies a gravitational force onto the distal end 60 of leg 48. Guide 61 is preferably parallel to the abutment edge 31 and may be formed of a separated strip fastened between the front and back plates by fasteners 63 within opening 22 and near side slot 28. Guide 61 also functions as a restraining piece to aid in locking/latching the pivoting release lever in place as discussed further below.

When collar assembly plate 32 is inserted edgewise into top opening 24, bottom edge 32 of collar assembly plate 32 applies a force (in the preferred mounting form, a gravitational force) on leg 48 that necessarily moves leg 50 about pivot 52 resulting in leg 50 moving upward and inward within side opening 26. When the sidewalls 38, 40 of collar 36 makes contact with the bottom edge 47 of opening 45 of front plate 20, the bottom edge 34 of collar assembly plate 32 has applied maximum force to leg 48 of pivoting release lever 16. In doing so, leg 48 is positioned below bottom edge 34 and directly above the joined front and back plate periphery. Leg 50 is correspondingly positioned within side slot 26 and adjacent guide 61 with the hold-down flange 58 positioned over a portion of the upper edge 33 of collar assembly plate 32 and, preferably, guide 61. In this way, hold-down flange 58 locks/latches upper edge 33 of collar assembly plate 32 within the top opening 24. Thus, the collar assembly 14 secured and locked to bracket assembly 12. Because of the pivoting action of the dual-pivoting release lever 16 and the spatial relationship of the release lever relative to the plate and bracket assembly, the locking function is accomplished in a single motion.

The collar assembly 14 is readily dislodged from the bracket assembly by the reverse procedure. When the collar assembly 14 (and attached device) are to be removed from the mounted bracket assembly 12, a force is applied to lip 56, which releases the hold-down flange 64 from restraining the upper edge 33 of collar assembly plate 32. At the same time, the force applied to lip 56 causes leg 48 to move upwardly of slot 22 such that the distal end 60 of leg 48 makes/forces the bottom edge 34 of collar assembly plate 32 to move upwards as the dual-pivoting release lever 16 is moved in a downward motion. The release action is accomplished in single motion that simultaneously unlocks and dislodges the collar assembly 14 for easy removal from the bracket assembly 12.

According to one embodiment, a notch 62 may be formed of one side of the upper 33 of collar assembly plate 32 to accommodate the shape of the hold-down flange 64 of the upper leg 58. As illustrated in FIGS. 1-2, notch 62 may take the shape of a square to conform to a cube-shaped hold-down flange 64. However, other corresponding shapes may be used and not deviate from the scope including a triangular or pointed end. This mating arrangement of the notch 62 and the hold-down flange 64 aids in keeping the upper edge 33 of collar assembly plate 32 restrained/locked until a force is applied to lip 56 to move dual-pivoting release lever 16 and dislodge the collar assembly plate.

Guide 61 not only forms a barrier to which restrains collar assembly plate 32 from lateral movement toward side slot 62 but guide 61 may also function to restrain upper leg 50 of the dual-pivoting release lever 16 from rotational movement into the part of slot 22 that collar assembly plate 32 is received. The upper portion 65 of guide 61 is positioned adjacent and below hold-down flange 64 in order to support and guide the hold-down flange locking positioning over a portion of the upper edge collar assembly plate 32 (and preferably to mate with notch 62).

The pivoting release lever's single motion locking action, especially within the confines of the guide and shape of the hold-down flange of the upper leg relative to the positioning of the upper edge of the collar assembly plate 14, all perform (lock, dislodge) in relative quiet. This nearly noiseless feature has benefits of being deployable in military environments and scenarios.

As will be discussed further below, the back surface 49 of back plate 18 is fixed directly or indirectly to a solid surface 46, whether a wall, column, floor, ceiling, belt, or vest. For relatively planar solid surfaces, back surface 49 is preferably and directly secured to the planar solid surface by means of fasteners (e.g., screws, nails, rivets), or it may be adhered to the surface. Other well-known fastening means for securing the back surface to the solid surface may be used as well. Securement of the bracket assembly to non-planar solid surfaces is discussed in more detail below.

Referring now to FIG. 3, one feature of the locking assembly is the ease to which a device 44 may be readily attached and detached from a solid surface 46, such as a wall. FIG. 3 illustrates one of many devices 44 to which easy attachment and detachment to a wall or other solid surface is desirable. In FIG. 3, a dog dish (device) 108 is fixedly attached to collar assembly 14. The entire dog dish 108 can be readily attached to wall 46 by inserting the plate of the collar assembly 14 into the slot 22 of the bracket assembly 12 and locking the top edge of the plate by the hold-down flange of the pivoting release lever (in any of the embodiments discussed above). The locking assembly 10 secures the dog dish 108 to the solid surface 46 more securely than known sliding latches. This locking assembly 10 application is particularly useful for rambunctious pets or pets that are wearing conical collars as part of medical convalescence. Similarly, the dish 108 is readily detached from the wall 46 (for cleaning, refilling, and the like) by unlocking the pivoting release lever and applying a downward force on the lever to dislodge the plate and collar assembly 14 from mounted bracket assembly 12.

At least the back plate of the bracket assembly 12 is fixedly attached to a solid surface (e.g., wall, ceiling, floor) through a plurality of fasteners, such as elongated screws or rivets that go through openings 27 that also join front and back plates together, or through adhesives or epoxies, magnets, or through other conventional fastening techniques. The locking assembly 10 of the present disclosure may be of various sizes, depending on the weight and size of the load being secured to the solid surface. For a small locking assembly carrying a relatively small weight, a single fastener may be utilized to secure at least the back plate to the solid surface. In one embodiment, the back plate of the bracket assembly 12 comprises a shape conforming to a non-planar solid surface, such as a curved light pole. In another embodiment, the locking assembly 10 may include back plate of the bracket assembly 12 comprises a shape configured to a banding, such as utility belt worn by a human.

Now referring to FIGS. 4-5, another embodiment of the locking assembly 10 may include a non-planar adapter plate 110 to having a planar front side 112 and a non-planar back side 114 of a size to conform to a non-planar solid surface 116. The adapter plate is fixedly attached to the back surface 49 of back plate 18 of bracket assembly 12 (fastened or adhered in FIG. 5). In the embodiment illustrated in FIGS. 4-5, the adapter plate 110 includes a slot 117 of a size and shape to support a band or belt that enters one side of the adapter plate and exits out the other side. The non-planar back side 114 is then fastened, banded, or otherwise fixedly adhered to the non-planar surface to which the device is desired to be attached. The non-planar back side 114 may be attached to the non-planar surface 116 as discussed above.

a band or belt 119 (or even rope) may be secured through the adapter plate, or even a slot within the back plate 18 discussed above, may be worn by a person in order to attach personal or tactical items in a substantially noiseless way. In the embodiment illustrated in FIG. 5, a soldier can quickly and quietly attach or detach important tactical equipment, such as flashlight 121 (as shown). Although the flanged lip may be used, a knurled outer radius about the hold-down flange is illustrated.

The locking assembly of all embodiments may be metal, such as brushed aluminum, or a lightweight plastic or other manmade material (e.g., GE's LEXAN brand plastic) or molded from a durable polymer. The locking assembly 10 may be of varying size per application. Additionally, more than one locking assembly may be required for certain applications.

Advantages of the present subject matter include a locking assembly or mechanism that can readily attach and lock a device to a solid surface or unlock and dislodge the device from the solid surface and that the locking/dislodging action is accomplished through a single motion defined by the pivoting release lever. The locking assembly of the present disclosure requires no complicated stored energy mechanism. Moreover, the smooth, pivoting action in connection with the locking mechanism functions to lock a device to a solid surface in which noise is minimized. The illustrated embodiments are only examples of the present disclosure and, therefore, are non-limiting. It is to be understood that many changes in the particular structure, materials, and features of the subject matter may be made without departing from the spirit and scope of this disclosure. Therefore, it is the Applicant's intention that his patent rights are not limited by the particular embodiments illustrated and described herein, but rather by the following claims interpreted according to accepted doctrines of claim interpretation, including the Doctrine of Equivalents and Reversal of Parts.

While the subject matter discussed herein is susceptible to various modifications and alternative constructions, certain illustrated embodiments thereof are shown in the drawings and have been described above in detail. Furthermore, those skilled in the art will understand that various aspects described in less than all of the embodiments may, nevertheless, be present in any embodiment. It should be understood, however, that there is no intention to limit the subject matter to the specific forms disclosed, but on the contrary, the intention is to cover all modifications, alternative constructions, and equivalents falling within the spirit and scope of the subject matter disclosed.

1. A locking assembly for securely attaching a device to a solid surface, the locking assembly comprising:
a bracket assembly having a front plate and a back plate spaced apart and forming a slot;
a collar assembly having a collar assembly plate configured to securely engage within the slot;
a pivoting release lever positioned adjacent to the collar assembly and the bracket assembly, the pivoting release lever further including:
a radial spring disposed between a lower leg member of the pivoting release lever and a middle leg member of the pivoting release lever, the radial spring attached to the bracket assembly such that the radial spring is configured to bias the collar assembly in a locked position in the slot when engaged; and
one or more compression springs disposed on the lower leg member, the one or more compression springs configured to bias an engaged collar assembly to be dislodged.

2. The locking assembly of claim 1, further comprising two compression springs disposed on the lower leg member.

3. The locking assembly of claim 1, further comprising a means for securing at least the back plate of the bracket assembly to a solid surface.

4. The locking assembly of claim 1, wherein the middle and lower legs of the pivoting release lever form a substantially L-shaped angle when joined at the pivot.

5. The locking assembly of claim 1, further comprising an upper leg of the pivoting release member pivotally attached to the middle leg member and configured to bias the collar assembly plate into an inserted position.

6. The locking assembly of claim 5, further comprising a hold-down flange positioned proximal of the upper leg and directed downward toward the lower leg member wherein the hold down flange is sized to fit over and closely confront a portion of the upper plate of the collar assembly plate when the collar assembly plate is inserted within the slot.

7. The locking assembly of claim 6, further comprising a notch in the collar plate assembly configured to engage the hold-down flange of the pivoting release lever.

8. The locking assembly of claim 1, wherein the back plate of the bracket assembly comprises a shape conforming to a non-planar solid surface.

9. The locking assembly of claim 1, wherein the back plate of the bracket assembly comprises a shape configured to a banding.

10. The locking assembly of claim 1, further comprising a second pivot point disposed between the upper leg member and the middle leg member.

11. The locking assembly of claim 10, further comprising a second radial spring radially disposed about the second pivot point and configured to bias the collar plate assembly in a locked position.

12. The locking assembly of claim 10, further comprising a radial body member disposed about the second pivot point and configured to provide rotation leverage to the upper leg member when rotational force is applied.

13. A locking assembly system, comprising:
a fixed attachment area;
a bracket assembly having a front plate and a back plate spaced apart and forming a slot;
a collar assembly having a collar assembly plate configured to securely engage within the slot;
a pivoting release lever positioned adjacent to the collar assembly and the bracket assembly, the pivoting release lever further including:
a radial spring disposed between a lower leg member of the pivoting release lever and a middle leg member of the pivoting release lever, the radial spring attached to the bracket assembly such that the radial spring is configured to bias the collar assembly in a locked position in the slot when engaged; and
one or more compression springs point disposed on the lower leg member, the one or more compression configured to bias an engaged collar assembly to be dislodged; and
a device securely biased in a locked position in the collar assembly by the dual-pivoting release lever.

14. The locking assembly system of claim 13 wherein the device comprises a fire extinguisher.

15. The locking assembly system of claim 13 wherein the device comprises a dog dish.

16. The locking assembly system of claim 13 wherein the device comprises a shelf.

17. The locking assembly system of claim 13 wherein the fixed attachment area comprises a wall.

18. The locking assembly system of claim 13 wherein the fixed attachment area comprises a belt.

19. The locking assembly system of claim 13, further comprising:
a radial body member disposed about the second pivot point and configured to provide rotation leverage to the middle leg member when rotational force is applied; and
a radial body member tool configured to engage to radial body member for providing additional rotational force for leverage.

20. The locking assembly system of claim 13, further comprising a second radial spring radially disposed about the second pivot point and configured to bias the collar plate assembly in a locked position.
